(19) United States
(12) Patent Application Publication
(10) Pub. No.: US 2021/0256869 A1
(43) Pub. Date: Aug. 19, 2021

(54) METHOD AND SYSTEM FOR AUTOMATICALLY SHARING PROCEDURAL KNOWLEDGE

(71) Applicant: SIEMENS AKTIENGESELLSCHAFT, München (DE)

(72) Inventors: Rebecca Johnson, München (DE); Asa MacWilliams, Fürstenfeldbruck (DE)

(21) Appl. No.: 17/255,841

(22) PCT Filed: Jun. 24, 2019
(86) PCT No.: PCT/EP2019/066599

§ 371 Date: Dec. 23, 2020

(30) Foreign Application Priority Data
Jun. 26, 2018 (EP) 18179905.7

(51) Int. Cl. G09B 19/00; G09B 5/12

(52) U.S. Cl. CPC G09B 19/003; G06F 3/167; G09B 5/125

(57) ABSTRACT

A system for automatically sharing procedural knowledge between domain experts of a technical domain and trainees is provided. The system includes at least one server connected via a communication network to computing devices of the domain experts and computing devices of the trainees.

This application is the National Stage of International Application No. PCT/EP2019/066599, filed Jun. 24, 2019, which claims the benefit of European Patent Application No. EP 18179905.7, filed Jun. 26, 2018. The entire contents of these documents are hereby incorporated herein by reference.

### BACKGROUND

The present embodiments relate to a system and a method for automatically sharing procedural knowledge between domain experts of a technical domain and trainees.

In many applications, users have to perform procedural steps in a procedure to be performed in a technical domain. For example, field service technicians have to maintain and/or repair a specific machine within a manufacturing facility. Another example is a medical expert having expertise how to perform a specific operation during surgery and wishes to share this knowledge with colleagues. Another doctor in a similar situation faced with surgical operation needs information how to proceed from another expert.

Sharing of procedural knowledge is conventionally done within teaching sessions where a domain expert demonstrates the procedure to a trainee or group of trainees. The domain expert may use instruction manuals or instruction videos.

The conventional approach of training trainees for technical procedures has several drawbacks. The domain expert having expert knowledge or expertise concerning the respective technical procedure may only teach or train a limited number of trainees at a time.

Further, the domain expert has to invest resources (e.g., time) for training other persons requiring training. Further, some domain experts may find it difficult to explain technical details to trainees because the technical details are deemed to be trivial or self-evident to the domain expert, thus making it difficult to train the trainees efficiently. Moreover, there may be language barriers between the training domain expert and the trained novices having less experience in the technical field.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a system and a method that increase the efficiency of sharing procedural knowledge between domain experts of a technical domain and trainees are provided.

The present embodiments provide, according to a first aspect, a system for automatically sharing procedural knowledge between domain experts of a technical domain and trainees. This system includes: at least one server connected via a communication network to computing devices of the domain experts and the computing devices of the trainees. Computing devices of the domain experts are adapted to provide the server with observations of actions and/or comments of the domain experts while performing a procedure in the technical domain. The server and/or the computing device includes a virtual assistant adapted to interact with the domain expert while performing the procedure in the technical domain to trigger observations of actions and/or comments of the respective domain expert. The received observations of actions and/or comments are evaluated by the server to automatically generate instructions for the trainees supplied to computing devices worn by the trainees while performing the respective procedure. The actions and/or comments recorded by the computing device of the domain experts while performing procedure steps of a procedure in the technical domain include audio data and/or video data tagged with labels associated with the respective procedure steps. The server includes a database adapted to store audio data and/or video data recorded for the domain experts and/or trainees along with the associated labels. A microphone of a user interface of the computing device of the domain expert is configured to receive specific comments of the domain expert including key words for labeling the audio data and/or video data. The server includes a processing unit adapted to extract relevant audio data and/or video data of the procedure steps stored in the database based on the associated labels to generate a training and/or guiding sequence for a procedure to be performed by the trainees including the extracted audio data and/or extracted video data.

In a possible embodiment of the system according to the first aspect, the server includes a virtual assistant adapted to interact with the trainee while performing the procedure in the technical domain to trigger observations of the actions and/or comments of the respective trainee.

In a possible embodiment of the system according to the first aspect, the virtual assistant implemented on the server or computing device includes an autonomous agent adapted to autonomously perform dialogues with the domain experts and/or trainees while performing the procedure in the technical domain to trigger actions and/or comments of the respective domain experts and/or trainees recorded by their computing devices and supplied to the server via the communication network of the system.

In a still further possible embodiment of the system according to the first aspect, the procedure context of a procedure performed by a domain expert or trainee and including machine data of a machine serviced by the respective domain expert E or trainee T in the procedure is retrieved automatically by the computing device worn by the respective domain expert or trainee and supplied to the server via the communication network.

In a further possible embodiment of the system according to the first aspect, the procedure context retrieved by the computing device includes machine data of a machine serviced by the respective domain expert or trainee in the respective procedure.

In a still further possible embodiment of the system according to the first aspect, the actions and/or comments of a domain expert or trainee recorded by a corresponding computing device during the procedure include audio data and/or video data that is automatically evaluated along with the procedure context of the procedure by the autonomous agent of the server to provide a dialogue with the respective domain expert and/or trainee and/or to give a feedback to the respective domain expert or trainee via the corresponding computing device.

In a still further possible embodiment of the system according to the first aspect, the actions and/or comments recorded by the computing device of a trainee in a selected operation mode while performing procedure steps of a procedure in the technical domain include audio data and/or video data tagged with labels associated with the respective procedure steps and/or the selected operation mode.

In a further possible embodiment of the system according to the first aspect, the labels associated with the respective procedure steps of a procedure are generated automatically based on specific actions and/or comments of the domain expert or trainee while performing the procedure in the technical domain and/or based on the procedure context of the procedure.

In a further possible embodiment of the system according to the first aspect, the processing unit of the server includes an artificial intelligence module adapted to extract relevant audio data and/or video data of procedure steps stored in the database automatically based on the associated labels and/or procedure context to generate the training and/or guiding sequence.

In a still further possible embodiment of the system according to the first aspect the training or guiding sequence is enriched by the processing unit with instructional data loaded from the database of the system for the respective procedure context.

In a still further possible embodiment of the system according to the first aspect, the instructional data used to enrich the training and/or guiding sequence includes data collected from different data sources including documentation data, machine data models, scanned data, recorded audio and/or video data of training and/or guiding sequences previously executed by a domain expert or by a trainee.

In a still further possible embodiment of the system according to the first aspect, each computing device is operated in selectable operation modes including a teaching mode where observations provided by the computing device are tagged automatically as expert observations and a learning mode, where observations provided by the computing device are tagged automatically as trainee observations.

The present embodiments further provide, according to a second aspect, a method for sharing automatically procedural knowledge.

The present embodiments provide, according to the second aspect, a method for automatically sharing procedural knowledge between domain experts and trainees. This method includes receiving, by a server, observations made by domain experts and provided by computing devices of the domain experts while performing a procedure in the technical domain. The received observations are processed by the server to automatically generate instructions for the trainees, and the generated instructions are provided by the server to computing devices worn by the trainees while performing the respective procedure in the technical domain.

The server and/or the computing device includes a virtual assistant adapted to interact with the domain expert while performing the procedure in the technical domain to trigger the observations of actions and/or comments of the respective domain expert. The actions and/or comments recorded by the computing devices of the domain experts while performing procedure acts of a procedure in the technical domain include audio data and/or video data tagged with labels associated with the respective procedure steps. The server includes a database adapted to store audio data and/or video data recorded for a plurality of domain experts and/or trainees along with the associated labels. A microphone of a user interface of the computing device of the domain expert is configured to receive specific comments of the domain expert including keywords for labeling the audio data and/or video data. The server includes a processing unit adapted to extract relevant audio data and/or video data of the procedure steps stored in the database based on the associated labels to generate training and/or guiding sequences for a procedure to be performed by the trainees including the extracted audio data and/or extracted video data.

### BRIEF DESCRIPTION OF THE DRAWINGS

FIG. 1 shows a block diagram illustrating a possible exemplary embodiment of a system for automatically sharing procedural knowledge according to a first aspect;

FIG. 2 shows a flow chart of a possible exemplary embodiment of a method for automatically sharing procedural knowledge according to a second aspect;

FIG. 3 shows an exemplary data structure of a data set as used by the system and method;

FIG. 4 schematically shows an illustration of a training and/or guiding sequence that may be generated by the method and system;

FIG. 5 illustrates a possible operation of a method and system; and

FIG. 6 illustrates a possible operation of the system and method as a virtual reality training authoring system.

### DETAILED DESCRIPTION

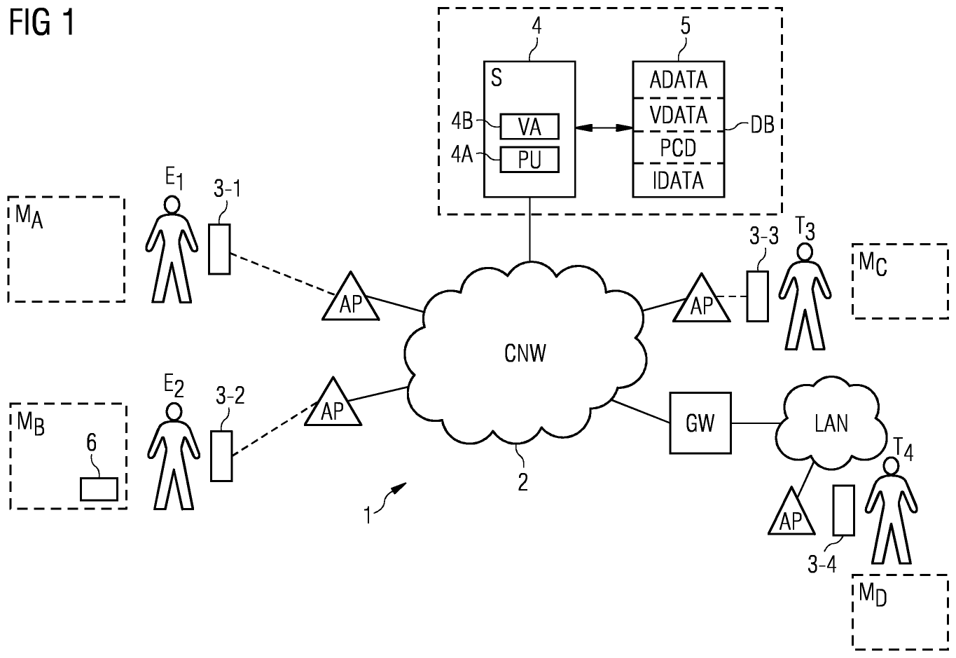

FIG. 1 schematically shows a possible exemplary embodiment of a system 1 for automatically sharing procedural knowledge between domain experts E of a technical domain and trainees T according to a first aspect of the present embodiments. In the illustrated exemplary embodiment, the system 1 includes a communication network 2 used for communication between computing devices 3-1, 3-2, 3-3, 3-4 of domain experts E and trainees T. The number of domain experts E and associated portable computing devices 3-i as well as the number of trainees T wearing portable computing devices 3-i may vary depending on the use case. In the illustrated exemplary embodiment, the different portable computing devices 3-i may be connected via wireless links to access points AP of the communication network 2 or indirectly via an access point of the local area network and a gateway GW as also illustrated in FIG. 1. The system or platform for automatically sharing procedural knowledge between different domain experts E and trainees T may include at least one central server 4 connected to the communication network 2. In the illustrated embodiment of FIG. 1, the server 4 has access to a central database 5 forming a data storage for audio data, video data, procedure context data, PCD, as well as instruction data (e.g., I data). The different experts E1, E2 as illustrated in FIG. 1 have expertise knowledge concerning the procedure to be performed in a technical domain. This procedure may be, for example, a repair procedure or a maintenance procedure of a machine M serviced by the respective expert E. As illustrated in FIG. 1, the machines Mₐ and M_{b} undergo a procedure by a technical expert E performing, for example, procedural steps of a maintenance or repair procedure. The computing devices 3-1, 3-2 of the domain experts E1, E2 are adapted to provide the server 4 of the platform or system 1 with observations of the domain experts E1, E2 while performing the procedure in the technical domain. The observations received by the server 4 are evaluated by a processing unit 4A of the server 4 to generate automatically instructions for the trainees T. The generated instructions may be supplied to the computing devices 3-3, 3-4 worn by the trainees T while performing the respective procedure at other machines M_{c}, M_{d} as illustrated in FIG. 1. In the illustrated embodiment, the server includes a processing unit 4A adapted to process the received observations to generate automatically instructions for the trainees T. Besides the processing unit 4A, the server 4 includes in the illustrated embodiment a virtual assistant 4B adapted to interact with the domain experts E1, E2 and/or with the trainees T3, T4 while performing the respective procedure in the technical domain to trigger or provoke observations, actions, and/or comments of the respective domain expert E and/or trainee T. In a possible embodiment, the virtual assistant 4B of the server 4 may include an autonomous agent adapted to autonomously perform dialogues with the domain experts E and/or trainees T while performing the procedure in the technical domain to trigger actions and/or to get comments of the respective domain experts E and/or trainees T recorded by their computing devices 3 and supplied to the server 4 via the communication network 2 of the system 1. In a possible embodiment, procedure context data PCD of a procedure performed by a domain expert E or a trainee T is retrieved automatically by the associated computing device 3 worn by the respective domain expert E or trainee T and supplied to the server 4 via the communication network 2. The procedural context data PCD of a procedure retrieved by a computing device 3 may include machine data of a machine M serviced by the respective domain expert E or trainee T in the procedure. Actions and/or comments of a domain expert E or a trainee T recorded by a corresponding computing device 3-i during the procedure may include audio data and/or video data. The audio data and video data may be evaluated automatically by the processing unit 4A along with the procedure context data PCD of the procedure to provide or create a dialogue with the respective domain expert E and/or trainee T. Further, the audio data and/or video data may be evaluated automatically by the processing unit 4A with the procedure context data PCD of the procedure to provide a feedback for the respective domain expert E and/or trainee T via a corresponding computing device 3-i.

As illustrated in FIG. 1, the server 4 has access to a database 5 adapted to store audio data and/or video data recorded for a plurality of domain experts E or trainees T along with the associated procedure context data PCD. In a possible embodiment, the actions and/or comments recorded by the computing device 3 of a domain expert E or a trainee T in a selected operation mode of a corresponding computing device 3 while performing procedural steps of the procedure are tagged with labels L associated with the respective procedure steps and/or selected operation mode. These labels L associated with the respective procedure steps of a procedure may be generated in a possible embodiment by the processing unit 4A automatically based on specific actions and/or comments of the domain expert E or trainee T while performing the procedure in the technical domain and/or based on the procedure context data PCD of the respective procedure.

The processing unit 4A of the server 4 may include a processor adapted to extract relevant audio data and/or video data of procedure steps stored in the database 5 based on the associated labels and/or based on the procedure context data to generate a training sequence or a guiding sequence for a procedure to be performed by a trainee T including the extracted audio data and/or extracted video data. The extraction of the relevant audio data and/or video data may be performed in a possible embodiment by an artificial intelligence module implemented in the processing unit 4A. In a possible embodiment, the training sequence or guiding sequence may be enriched by the processing unit 4A with instructional data loaded from the database 5 of the system for the respective procedure context. Instructional data may include, for example, data collected from different data sources including, for example, documentation data from machine data models of a machine M or machine components, scanned data, and/or recorded audio and/or video data of training and/or guiding sequences previously executed by a domain expert or trainee. In a possible embodiment, each computing device may be operated in different operation modes OM. These selectable operation modes may include, for example, a teaching operation mode (T-OM), where observations provided by the computing device 3 are tagged as expert observations, and a learning operation mode (L-OM), where observations provided by the computing device 3 are tagged automatically as trainee observations.

The computing devices 3-i carried by the experts E and/or trainees T are, in an embodiment, portable computing devices that may be carried by the expert or trainee or are attached to the expert or trainee. This wearable computing devices 3-i may include in a possible exemplary embodiment one or more cameras worn by the user at his head, chest, or arms. Wearable computing devices 3 may further include a user interface including one or more microphones arranged to record the voice of the user. Further, the user interface of the wearable computing device 3 may include one or more loudspeakers or headphones. Further, each wearable computing device 3-i includes a communication unit that allows to set up a communication with the server 4 of the platform 1. Each wearable computing device 3 includes at least one processor with appropriate application software. The processor of the computing device 3 is connected to the user interface UI of the wearable computing device 3 to receive sensor data (e.g., video data from the cameras and/or audio data from the microphones). The computing unit or processor of the wearable computing device 3 is adapted in a possible embodiment to provide observations of the user while performing the procedure in the technical domain and to transmit the observations via the communication interface of the computing device 3 and the communication network 2 to the server 4 of the platform. In a possible embodiment, the computing unit of the device 3-i is adapted to preprocess data received from the cameras and/or microphones to detect relevant actions and/or comments of the user. These actions may include, for example, the picking up of a specific tool by the expert E or trainee T during the procedure in the technical domain such as a repair or maintenance procedure. The detection of a relevant action may be performed in a possible exemplary implementation by processing audio comments of the user (e.g., the expert E or a trainee T or by detection of specific gestures based on processed video data).

In a possible embodiment, the software agent 4B of the server 4 is adapted to interact with users and may include, for example, a chatbot providing a voice based interface to the users. The virtual assistant VA including the chatbot may, for example, be adapted to interact with the domain expert E and/or trainee T while performing the procedure in the technical field. The virtual assistant VA may include a chatbot to autonomously perform a dialogue with the respective user. The dialogue performed between the chatbot and the user may be aligned with actions and/or comments made by the user. For example, if video data provided by the computing device 3 of the user show that the user picks up a specific tool to perform a procedural step during the maintenance or repair procedure, the chatbot of the virtual assistant VA may generate a question concerning the current action of the user. For example, the chatbot of the virtual assistant VA may ask a technical expert E a specific question concerning his current action such as “what is the tool you just picked up?”. The comment made by the expert E in response to the question may be recorded by the computing device 3 of the expert E and transmitted to the server 4 of the system to be memorized in the database 5 as audio data of a procedural step of the repair or maintenance procedure performed by the expert E. After the expert E has picked up the tool and has answered the question of the chatbot, the expert E may start to perform maintenance or repair of the machine. The computing device 3 of the expert E automatically records a video of what the expert is doing along with potential comments made by the expert E during the repair or maintenance action performed with the picked up tool. The actions and/or comments of the domain expert E recorded by the corresponding computing device 3, during the procedure may include audio data including the expert's comments and/or video data showing the expert's actions that may be evaluated in a possible embodiment by an autonomous agent of the virtual assistant VA to provide or generate dialogue elements output to the expert E to continue with the interactive dialogue. In parallel, procedure context of the procedure performed by the expert E may be retrieved by the computing device 3 worn by the expert and supplied to the server 4 via the communication network 2. These context data may include, for example, machine data read from a local memory of the machine M that is maintained or repaired by the expert E. In the example illustrated in FIG. 1, the machine M_{b} that is serviced by the domain expert E2 includes a local memory 6 storing machine data of the machine M_{b} that may be retrieved by the computing device 3-2 of the expert and forwarded to the server 4 of the platform. The context data of the process may, for example, indicate a machine type for identification of the machine M_{b} that may be stored in the database as procedure context data PCD. The server 4 may store audio data and/or video data recorded for a procedural step of a procedure along with associated procedure context data PCD in the database 5. In a possible embodiment, these audio data and/or video data may be tagged with labels L associated with the respective procedural step. The labels may be automatically generated by the processing unit 4A based on specific actions and/or comments of the user while performing the procedure in the technical domain. In a possible embodiment, comments made by the user during the procedure may be processed to detect key words that may be used as procedure context data PCD for the respective procedure. The labels and/or tags of audio data and/or video data generated as observations by the computing device 3 of the respective user may be stored as procedure context data PCD for the respective audio data and/or video data along with the audio data and/or video data in the database 5 of the system. The tagging and/or labelling may be performed in a possible embodiment automatically (e.g., based on machine data read from a local memory of the machine M). In a further possible embodiment, the tagging may be made by the expert E or user during the procedure by specific comments spoken into a microphone of the user interface UI of the computing device 3 including, for example, key words for labelling the audio and/or video data provided by the sensors of the computing device of the user. The wearable computing devices 3 of the trainees T may include, in a possible embodiment, an additional display unit worn on the trainee's head to provide the trainee T with a guiding or training sequence regarding the handling of the respective machine.

The chatbot of the virtual assistant VA ma also perform a dialogue with the trainee T (e.g., to receive questions of the trainee during the procedure such as “which of these tools do I need now?”). The virtual assistant VA may play back previously recorded videos of experts E showing what the experts E are doing in a particular situation during a maintenance and/or repair procedure. The virtual assistant VA may further allow the trainee T to provide a feedback of how useful a given instruction has been for his purpose to the system.

The database 5 of the platform is adapted to index or tag procedure steps for individual video and/or audio data sequences. The processing unit 4A may include, in a possible embodiment, an artificial intelligence module AIM that is adapted to extract relevant pieces of recorded video and/or audio sequences and to index the relevant pieces of recorded video and/or audio sequences according to the comments made by the expert E in a specific situation of the procedure as well as based on the data that is included in the video sequences or audio sequences. The artificial intelligence module AIM may be configured in a possible embodiment to query the database 5 for appropriate video data when a trainee T requires the video data during a procedure. In a possible embodiment, the server 4 may also send communication messages such as emails to the users and may, in a possible embodiment, also send rewards to experts E who have shared useful knowledge with trainees T.

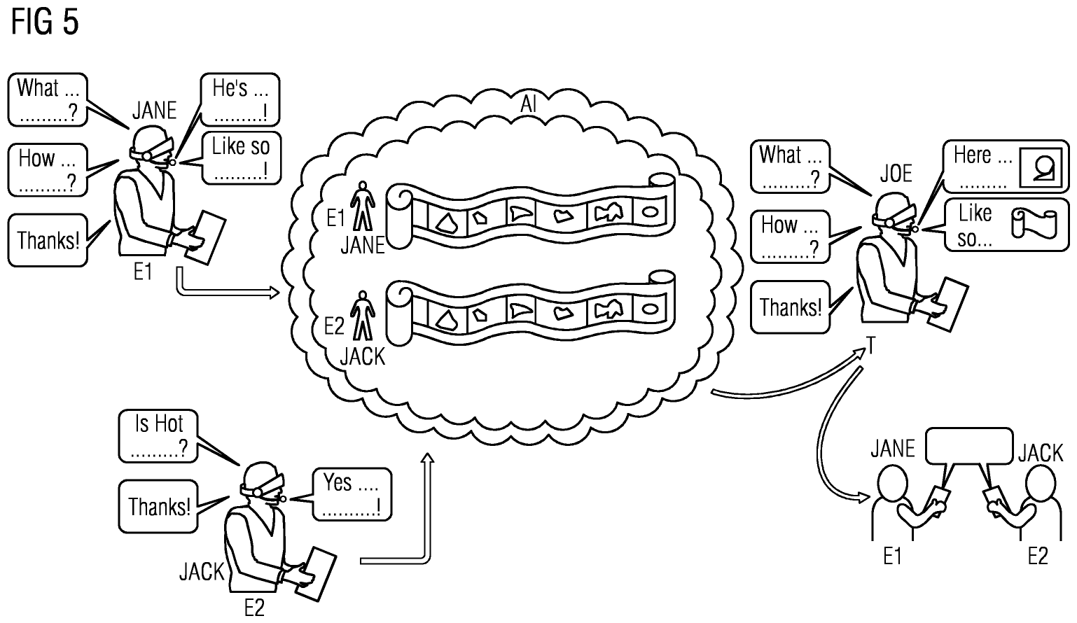

FIG. 5 schematically shows an example illustrating an interaction of a system, according to the present embodiments, with users. In the illustrated example, two experts, “Jane” (E1) and “Jack” (E2), are connected by corresponding portable computing devices 3 with the system 1 for automatically sharing procedural knowledge with a trainee “Joe” (T).

A possible dialogue between the experts E and the trainee T may be as follows. First, the first expert “Jane” (E1) is working in a procedure (e.g., in a repair or maintenance procedure at a machine Mₐ). During the operation, the actions and/or comments of the domain expert “Jane” (E1) are monitored by a corresponding computing device 3-1 to detect interesting actions and/or comments during the procedure. In a possible embodiment, the computing device 3 includes an integrated virtual assistant VA adapted to interact with the user by performing the procedure that may, in a possible implementation, also be supported by the virtual assistant VA integrated in a module 4B of the server 4. If the computing device 3 detects that the first expert “Jane” (E1) is performing something interesting, the chatbot of the virtual assistant VA may ask the first expert “Jane” (E1) a question.

Computing device 3 of “Jane” (E1): “Excuse me, Jane, what is that tool you've been using?”

Reply of expert “Jane” (E1): “Oh, that's a screwdriver, I need to fix the upper left screw of the housing.”

The chatbot may then ask via the computing device 3 of the expert “Jane”: “Ah, how do you fix the screw in the housing?”, which triggers the reply of the technical expert “Jane”: “See, like this, right here”, while the domain expert performs the action of fixing the screw in the housing of the machine recorded by the camera of corresponding computing device 3. The dialogue may be finalized by the chatbot of the virtual assistant VA as follows “Thank you!”

Later, if the second expert “Jack” (E2) is taking a similar machine M apart, the processing unit may continuously evaluate video and/or audio data provided by the computing device to detect procedural steps performed by the expert. In the example, an artificial intelligence module AIM of the processing unit 4A may have learned from the previous recording of the other expert “Jane” (E1) that the video data shows a specific component or element (e.g., the screw previously assembled in the housing of the machine M by the first expert “Jane”). After having made this observation, the chatbot of the virtual assistant VA may ask the second expert “Jack” (E2) a question as follows: “Excuse me, Jack, is that a screw which you want to use to assemble the housing?”. This may trigger the following reply of the second expert “Jack”: “Yes, indeed it is . . . ”. The chatbot of the virtual assistant VA may then end the dialogue by thanking the second expert “Jack”: “Thank you!”

Later, the trainee T may have the task to fix the housing by assembling the screw and has no knowledge or expertise to proceed as required. The trainee T may ask via computing device 3 the platform for advice in the following dialogue. The trainee “Joe” may ask: “Ok, artificial intelligence module, please tell me what is this screw that I am supposed to use to fix the housing?” The computing device 3 of the trainee “Joe” may output, for example: “It's this thing over here . . . ”.

The same moment the platform shows the trainee “Joe” using the display of his computing device 3 an image or video recorded previously by the computing device 3 of the second expert “Jack” (E2) with the respective component (e.g., the screw) highlighted, the trainee “Joe” may then ask via corresponding computing device 3 the system the follow-up question: “Ok, and how do I fix it?”. gjo?? The reply output by the user interface UI of the computing device 3 of the trainee T may be: “You may use a screwdriver as shown . . . ”, where the display of the trainee “Joe” outputs the video sequence that has been recorded by the computing device 3 of the first expert “Jane”. The trainee T may end the dialogue, for example, by the following comment: “Thanks, that helped!”.

Finally, both experts “Jack” and “Jane” may receive thanks from the system via an application on corresponding portable computing devices 3. For example, the portable computing device 3 of the first expert “Jane” (E1) may display the following message; “Thanks from Joe for your help in assembling housing of the machine using a screwdriver!” Also on the computing device 3 of the other expert “Jack” (E2), a thank you-message may be output as follows: “Thanks from Joe on identifying the screw!”

The system according to the present embodiments may take advantage of an interaction format of chatbot to ask experts E in the technical domain questions. The chatbot of the virtual assistant VA implemented on the portable computing device 3 and/or on the server 4 of the platform may put the expert E into a talkative mood so that the expert E is willing to share expert knowledge. Similarly, the chatbot implemented on the computing device a3 of a trainee T or on the server 4 of the platform will reduce the trainee's inhibition to ask questions so that the trainee T is more willing to ask for advice. The system 1 may record and play videos on the wearable computing devices 3 so that the trainee T may see video instructions from the same perspective as during the actual procedure. The system 1 may further use audio tracks from recorded videos evaluated or processed to extract index certain elements in the video sequence. Further, the system may provide experts E with rewards for sharing their expert knowledge with trainees T. The system 1 does not require any efforts to explicitly offer instructions. The experts E may share knowledge when asked by the chatbot without slowing down work process during the procedure. Accordingly, the observations of the domain experts E may be made during a routine normal procedure of the expert E in the respective technical domain. Accordingly, in the normal routine, the expert E may provide knowledge to the system 1 when asked by the chatbot of the virtual assistant VA.

In contrast to conventional platforms, where an expert E explicitly teaches trainees T who may stand watching, the system of the present embodiments may scale indefinitely. While a trainer may only teach two or more trainees at a time, the content recorded and shared by the system 1 may be distributed to an unlimited number of distributed trainees T.

In a possible embodiment, the system 1 may also use contextual data of machines or target devices. For example, the computing device 3 of an expert E may retrieve machine identification data from a local memory of the machine M that the expert E is servicing including, for example, a type of the machine. This information may be stored along with the recorded audio and/or video data in the database 5. Similarly, the computing device 3 of a trainee T may query the machine M that the trainee T is servicing, and an artificial intelligence module AIM of the processing unit 4A may then search for video and/or audio data of similar machines.

In another possible embodiment, additional instructional material or data is stored in the database 5 (e.g., part diagrams or animated 3D data models). For example, the computing device 3 of the trainee T may show a three-dimensional diagram of the machine M being serviced by the trainee T. This three-dimensional diagram may be stored in the database 5 of the system 1, and the trainee T may query for the three-dimensional diagram explicitly so that, for example, the artificial intelligence module AIM will suggest the three-dimensional diagram to the trainee T as follows: “may I show you a model of the machine component?”. There are several possible mechanisms for providing additional data (e.g., additional instructional data that may be linked to the recorded video and/or audio data without explicit annotation). For example, if an expert E looks at a particular three-dimensional data model on a portable computing device 3 when performing a procedure or task, this may be recorded by the portable computing device 3. The same model may then be shown to the trainee T when performing the same task. Further, if each data model includes a title, a trainee may search for an appropriate data model by voice commands input in the user interface UI of the computing device 3.

In a possible embodiment, the artificial intelligence module AIM implemented in the processing unit 4A of the server 4 may include a neural network NN and/or a knowledge graph.

In a possible embodiment, the computing device 3 of a trainee T may also be configured to highlight particular machine parts in an augmented reality (AR) view on the display of the computing device 3 of the trainee. The computing device 3 of the trainee T may include a camera similar to the computing device of an expert E. The computing device 3 of the expert E may detect, in a possible embodiment, items in the trainee's current view that also appear in a recorded video of the expert E, and the computing device 3 of the trainee T may then highlight the items if the items are relevant.

In a possible embodiment, the computing devices 3 of the trainee T and expert E may be the same in terms of hardware and/or software. In this embodiment, the computing devices 3 include both cameras and display units. Accordingly, colleagues may use these computing devices to share knowledge symmetrically (e.g., a trainee T in one technical area may be an expert E in another technical area and vice versa).

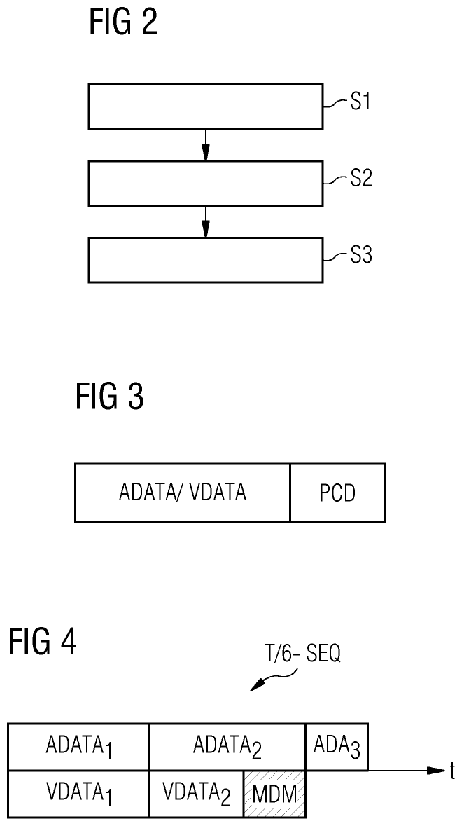

FIG. 2 shows a flowchart of a possible exemplary embodiment of a method for automatically sharing procedural knowledge between domain experts E and trainees T. The method illustrated in FIG. 2 may be performed using a platform as illustrated in FIG. 1.

In a first act S1, the server receives observations made by computing devices of domain experts E by performing a procedure in the technical domain.

In a further act S2, the received observations are processed by the server to automatically generate instructions for trainees T.

In a further act S3, computing devices worn by trainees T while performing the respective procedure in the technical domain are provided by the server with the generated instructions.

FIG. 3 schematically illustrates a possible data structure that may be used by the method and system according to the present embodiments. Recorded audio data and/or video data will be stored along with procedure context data (PCD) in the database 5 of the platform. The procedure context data PCD may include, for example, machine data of the machine M serviced by the respective domain expert E and/or trainee T during a maintenance or repair procedure. Further, the procedure context data PCD may include labels L generated during the recording of the audio data and/or video data. The procedure context data PCD may, for example, include labels L associated with respective procedure steps and/or selected operation modes OM. In a possible embodiment, each computing device 3-i of the platform may be operated in one group of selectable operation modes. These operation modes OM may include, in a possible implementation, a teaching operation mode T-OM, where observations provided by the computing device 3 are tagged automatically as expert observations. Further, the operation mode may include a learning operation mode L-OM, where observations provided by the computing device 3 are tagged automatically as trainee observations. These tags or labels may be stored as procedure context data PCD along with the recorded audio data and/or video data. The labels L stored as procedure context data PCD may also be generated in response to comments made by a user during the procedure. Further, the procedure context data PCD may be automatically generated by actions recorded as video data during the procedure (e.g. specific gestures made by the user). The procedure context data PCD may include a plurality of further information data generated automatically during the procedure (e.g., time stamps indicating when the audio data and/or video data have been recorded, location data indicating the location where the audio data and/or video data have been recorded, as well as user profile data providing information about the user having performed the procedural step within a procedure including information about the level of knowledge of the respective user, such as whether the user is regarded as an expert E or a trainee T for the respective procedure). Other possible procedure context data PCD may include information about the language spoken by the respective user.

FIG. 4 illustrates a training and/or guiding sequence output by the platform using data stored in the database 5 of the platform. The processing unit 4A of the server 4 may be adapted to extract relevant audio data and/or video data of procedure acts stored in the database 5 based on associated procedure context data PCD to generate or assemble a training and/or guiding sequence for a trainee T including the extracted audio data and/or extracted video data. In the illustrated embodiment, recorded audio data and/or recorded video data stored in the database 5 may be output via the computing device 3 of a trainee T according to a dialogue performed between the trainee T and the chatbot of the virtual assistant VA implemented in the computing device 3-i of the trainee T or on the server 4 of the platform. The recorded audio data and video data may be output simultaneously in parallel as different information channels via the display unit of the portable computing device 3 of the trainee T and via the headphones of the user interface of the computing device 3 of the trainee T. In the illustrated example of FIG. 4, first audio data ADATA1 recorded from a first expert E1 may be displayed to the trainee T along with video data showing the actions of this expert E1. The next procedural act within the procedure may be explained to the trainee T by further audio data ADATA2 recorded from a second expert E2 along with video data showing the actions of this other expert E2 as VDATA2. In the illustrated example, the length of the video data stream VDATA2 is shorter than the audio data ADATA2 of the expert E2 and is followed by instruction data (e.g., a machine data model MDM of the respective machine component handled by the second expert E2 during this procedure step). The training sequence or guiding sequence illustrated in FIG. 4 may be followed by acoustic data ADATA3 of a third expert E3 explaining a further procedural step without available video data. As shown, the training sequence or guiding sequence includes a series of audio data sets and/or video data sets concatenated or linked using procedure context data PCD. In a possible embodiment, the training sequence or guiding sequence for a procedure to be performed by a trainee T includes extracted audio data and/or extracted video data stored in the database 5 of the platform. The training or guiding sequence may be enriched by the processing unit 4A in a possible embodiment with instructional data loaded from the database 5 of the system for the respective procedure context data PCD. This instructional data used to enrich the training and/or guiding sequence may include data collected from different data sources including documentation data, machine data models, scanned data, recorded audio, and/or video data of training and/or guiding sequences previously executed by a domain expert or trainee. The collected data may include data provided by different data sources including CAD models of machines M to be maintained, photographs or videos of real maintenance procedures, and/or three-dimensional scans of special tools or parts. The CAD models of machines to be maintained typically include construction models, not necessarily designed for training. The CAD models may be simplified and converted into a format appropriate for training (e.g., by removing small parts or components from the model that are not visually relevant for the training process). This may be accomplished in a possible embodiment by an automatic model conversion and simplification process performed by the processing unit 4A of the server 4.

The data sources may also provide photographs or videos of real maintenance procedures. These may be available from previous live training sessions. Additional, non-VR documentation may be used such as sketches or slides. These documents may be automatically converted in a possible embodiment to images forming additional instructional data. Further, the data sources may include three-dimensional scans of special tools or parts. If special tools or parts are not available as CAD models, three-dimensional scans may be generated or created for these user parts from physical available parts using laser scanners or photogrammetric reconstructions.

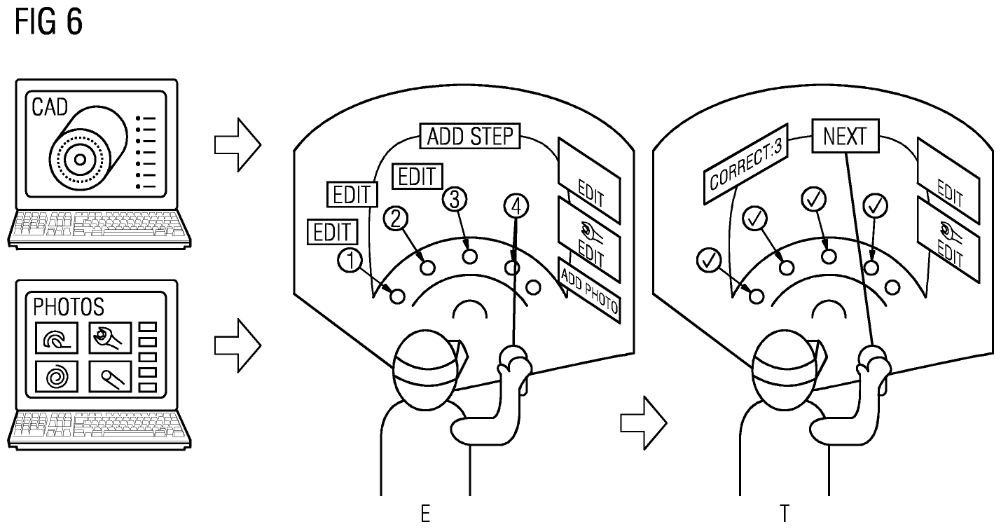

The pre-existing data such as CAD models or photographs, may be imported by the platform into a virtual reality VR training authoring system as also illustrated schematically in FIG. 6. Domain expert E may use the VR training authoring system that allows the domain expert E to specify the task procedures that the trainee T is supposed to learn (e.g., within a virtual reality VR environment). The implemented authoring system may include, in a possible embodiment, a process of highlighting or selecting different parts of the imported CAD model or the scanned special tools in VR. A further function of the system 1 may be a process adapted to select pre-existing images or photographs from a set of images that has been imported by the system 1 from a data source.

The system 1 may include a library stored in the database including predefined tools such as wrenches, screwdrivers, hammers, etc., as well as ways of selecting the predefined tools in virtual reality (VR). The platform may also provide a function of specifying atomic actions in VR such as removing a specific screw with a specific wrench. The platform or system 1 further includes, in a possible embodiment, a function of creating sequences of actions (e.g., remove a first screw, then remove a second screw, etc.). The platform can further provide a function of arranging images, videos, sketches, and/or other non-virtual reality documentation data in helpful positions within the three-dimensional environment optionally associated with a specific step in the sequence of actions. The platform may further provide a function of saving a sequence of actions with added supporting photographs as a training and/or guiding sequence.

The trainee T may use the VR training authoring system provided by the platform. The system may allow importing a sequence of actions and arrangements of supporting images or photographs specified by an expert E in the authoring system, making the sequence available as a VR training experience to the trainee T. The platform may provide a function of displaying a CAD model, specialized tools, standard tools, and supporting photographs on the display unit of a computing device 3 worn by the trainee T in virtual reality VR. The trainee T may perform atomic actions in VR such as removing a specific screw with a specific wrench. In the teaching mode, parts and tools to be used in each atomic action within the atomic action sequence may be highlighted by the platform. In a possible examination mode, parts or components of the machine M serviced by the trainee T are not highlighted, but the trainee T may receive a feedback on whether the procedure step has been performed correctly or not by the trainee T.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for automatically sharing procedural knowledge between domain experts of a technical domain and trainees, the system comprising:
at least one server connected via a communication network to computing devices of the domain experts and computing devices of the trainees,
wherein the computing devices of the domain experts are adapted to provide the server with observations of actions, comments, or actions and comments of the domain experts while performing a procedure in the technical domain,
wherein the server, the computing device, or the server and the computing device comprise a virtual assistant adapted to interact with the domain expert while performing the procedure in the technical domain to trigger observations of actions, comments, or actions and comments of the respective domain expert,
wherein the received observations of actions, comments, or actions and comments are evaluated by the server to generate automatically instructions for the trainees supplied to computing devices worn by the trainees while performing the respective procedure,
wherein the actions, comments, or actions and comments recorded by the computing device of the domain experts while performing procedure steps of a procedure in the technical domain comprise audio data, video data, or audio data and video data tagged with labels associated with the respective procedure steps,
wherein the server comprises a database adapted to store audio data, video data, or audio data and video data recorded for the domain experts, trainees, or domain experts and trainees along with the associated labels,
wherein a microphone of a user interface of the computing device of the domain expert is configured to receive specific comments of the domain expert comprising key words for labeling the audio data, video data, or audio data and video data, and
wherein the server comprises a processing unit adapted to extract relevant audio data, video data, or audio data and video data of the procedure steps stored in the database based on the associated labels, such that a training, guiding, or training and guiding sequence for a procedure to be performed by the trainees including the extracted audio data, extracted video data, or extracted audio data and extracted video data is generated.

2. The system of claim 1, wherein the server, the computing device, or the server and the computing device comprise a virtual assistant adapted to interact with trainee while performing the procedure in the technical domain to trigger observations of actions, comments, or actions and comments of the respective domain expert trainee.

3. The system of claim 2, wherein the virtual assistant implemented on the server or the computing system comprises an autonomous agent adapted to perform autonomously a dialogue with the domain expert, the trainee, or the domain expert and the trainee while performing the procedure in the technical domain to trigger actions, comments, or actions and comments of the respective domain expert, trainee, or domain expert and trainee recorded by corresponding computing devices and supplied to the server via the communication network of the system.

4. The system of claim 1, wherein procedure context of a procedure performed by the domain expert or the trainee and comprising machine data of a machine serviced by the respective domain expert or trainee in the procedure is automatically retrieved by the computing device worn by the respective domain expert or trainee and supplied to the server via the communication network.

5. The system of claim 4, wherein the procedure context of a procedure retrieved by the computing device comprises machine data of a machine serviced by the respective domain expert or trainee during the procedure.

6. The system of claim 4, wherein the actions, comments, or actions and comments of a domain expert or trainee recorded by the corresponding computing device during the procedure comprise audio data, video data, or audio data and video data that are evaluated automatically along with the procedure context of the procedure by the autonomous agent of the server, such that a dialogue with the respective domain expert or trainee is provided, feedback is given to the respective domain expert or trainee via the corresponding computing device, or a combination thereof.

7. The system according to of claim 1, wherein the actions, comments, or actions and comments recorded by the computing device of a trainee while performing procedure steps of a procedure in the technical domain comprise audio data, video data, or audio data and video data tagged with labels associated with the respective procedure steps.

8. The system of claim 7, wherein the labels associated with the respective procedure steps of a procedure are generated automatically based on specific actions, specific comments, or specific actions and specific comments of the domain expert or trainee while performing the procedure in the technical domain, based on the procedure context of the procedure, or a combination thereof.

9. The system of claim 8, wherein the processing unit comprises an artificial intelligence module adapted to extract relevant audio data, video data, or audio data and video data of procedure steps stored in the database automatically based on the associated labels, based on the procedure context, or based on a combination thereof, such that the training sequence, the guiding sequence, or the training and guiding sequence are generated.

10. The system of claim 8, wherein the training sequence or the guiding sequence is enriched by the processing unit with instructional data loaded from the database of the system for the respective procedure context.

11. The system of claim 10, wherein the instructional data used to enrich the training sequence, the guiding sequence, or the training and guiding sequence comprises data collected from different data sources including documentation data of machine data models, scanned data, recorded audio, video data, or any combination thereof of training, guiding, or training and guiding sequences previously executed by a domain expert, trainee, or domain expert and trainee.

12. The system according to of claim 1, wherein each of the computing devices is operated in a selectable operation mode including a teaching mode, wherein observations provided by the respective computing device are tagged automatically as expert observations, and a learning mode, wherein observations provided by the respective computing device are tagged automatically as trainee observations.

13. A method for automatically sharing procedural knowledge between domain experts and trainees, the method comprising:
receiving, by a server, observations of actions, comments, or actions and comments made by domain experts and provided by computing devices of the domain experts while performing a procedure in the technical domain;
processing, by the server, the received observations of actions comments, or actions and comments, such that instructions are automatically generated for trainees; and
providing, by the server, the generated instructions to computing devices worn by the trainees while performing the respective procedure in the technical domain,
wherein the server, the computing device, or the server and the computing device comprise a virtual assistant adapted to interact with the domain expert while performing the procedure in the technical domain to trigger the observations of actions, comments, or actions and comments of the respective domain expert,
wherein the actions, comments, or actions and comments recorded by the computing devices of the domain experts while performing procedure steps of a procedure in the technical domain comprise audio data, video data, or audio data and video data tagged with labels associated with the respective procedure steps,
wherein the server comprises a database adapted to store audio data, video data, or audio data and video data recorded for a plurality of domain experts, trainees, or domain experts and trainees along with the associated labels,
wherein a microphone of a user interface of the computing device of the domain expert is configured to receive specific comments of the domain expert comprising key words for labeling the audio data, and/or video data, or audio data and video data, and
wherein the server comprises a processing unit adapted to extract relevant audio data, video data or audio data and video of the procedure steps stored in the database based on the associated labels, such that training, guiding, or training and guiding sequences for a procedure to be performed by the trainees including the extracted audio data, extracted video data, or extracted audio data and video data are generated.
